(19) United States
(12) Patent Application Publication
(10) Pub. No.: US 2013/0252040 A1
(43) Pub. Date: Sep. 26, 2013

(54) HEAT CONTROL PLATE FOR BATTERY CELL MODULE AND BATTERY CELL MODULE HAVING THE SAME

(71) Applicants: Jin Woo Kwak, Suwon (KR); Kyong Hwa Song, Seoul (KR); Han Saem Lee, Ansan (KR); Young Joon Chang, Uiwang (KR); Byung Sam Choi, Suwon (KR)

(72) Inventors: Jin Woo Kwak, Suwon (KR); Kyong Hwa Song, Seoul (KR); Han Saem Lee, Ansan (KR); Young Joon Chang, Uiwang (KR); Byung Sam Choi, Suwon (KR)

(73) Assignee: HYUNDAI MOTOR COMPANY, Seoul (KR)

(21) Appl. No.: 13/539,826

(22) Filed: Jul. 2, 2012

(30) Foreign Application Priority Data
Mar. 22, 2012 (KR) 10-2012-0029590

(51) Int. Cl. H01M 10/50

(52) U.S. Cl. 429/62; 429/120

(57) ABSTRACT

The present invention provides a heat control plate and a battery cell module having the same. The heat control plate is used as an interfacial component interposed between battery cells. The heat control plate includes a planar composite sheet, a plurality of heat radiating ribbons, a planar heating layer, and a conductive strap. The plurality of heat radiating ribbons penetrate the composite sheet and protrude from both right and left sides of the composite sheet at both ends thereof. The planar heating layer is attached to one or both of upper and lower surfaces of the composite sheet and generates heat upon application of a voltage. The conductive strap applies a supply voltage to the planar heating layer. The planar composite sheet can have a high thermal conductivity. The planar composite sheet can have a thermal conductivity greater than about 3 W/mK.

### CROSS-REFERENCE TO RELATED APPLICATION

This application claims under 35 U.S.C. §119(a) the benefit of Korean Patent Application No. 10-2012-0029590 filed Mar. 22, 2012, the entire contents of which are incorporated herein by reference.

### TECHNICAL FIELD

The present invention relates to a heat control plate and a battery cell module having the same. More particularly, it relates to a heat control plate and a battery cell module having the same, which maintain an optimum temperature of a battery under various operation and temperature conditions.

### BACKGROUND

Because the reliability and the stability of battery systems are the most important factors that determine the marketability of electric vehicles, such battery systems need to be maintained within an optimum temperature range of 35° C. to 40° C. to prevent the reduction of the battery performance according to the variation of external temperature. For this, the battery systems need to be maintained within an optimum temperature range under a lower temperature environment while carrying excellent heat radiation performance under typical climate conditions.

Generally, when the external temperature drops below −10° C., the energy and power of lithium ion batteries rapidly decreases. For example, it is reported that type 18650 batteries can supply only 5% of the energy density and 1.25% of the power density in an environment of 40° C. below zero compared to an environment of 20° C. (Ref, G. Nagasubramanian, J. Appl. Electrochem. 31 (2001) 99).

It is also reported that lithium ion batteries show normal discharging but abnormal charging under low temperature environments (Ref, C. K. Huang, J. S. Sakamoto, J. Wolfenstine, S. Surampudi, and J. Electrochem. Soc. 147 (2000) 2893; S. S. Zhang, K Xu, T. R. Jow, Electrochim. Acta 48 (2002) 241).

The reduction of the battery performance under a low temperature environment can cause reduction of ion conductivity of electrolytes in batteries, solid electrolyte membranes formed on the surface of graphite, low diffusion of lithium ions into graphite, and increase of charge transfer resistance at an interface between an electrolyte and an electrode part (Ref, S. S. Zhang, K Xu, T. R. Jow, J of Power Sources 115 (2003) 137). In order to overcome these limitations, a separate heating system is needed to maintain a battery cell within an optimum temperature range of 35° C. to 40° C.

In batteries for electric vehicles, however, local temperature differences and high heat can occur due to heat generated by high-output, high-speed, and repetition of charging and discharging, causing thermal runaway that hinders the efficiency and stability of batteries.

The thermal runaway results from deficiency of the heat radiation and diffusion capacity to the outside compared to heat generated in batteries.

Also, in a pouched type of battery cell that is recently being widely used, volume varies due to intercalation/deintercalation of lithium ions to/from electrode material during charging/discharging.

Since the damage of the separator between electrode materials due to expansion of the electrode in the battery cell incurs generation of internal resistance, increase of voltage, reduction of battery performance, and reduction of the final battery capacity, a heat radiation interfacial member (member disposed between battery cells) is needed to accommodate the volume expansion of the battery.

When the volume of a battery cell in a typical battery system increases, an air cooling channel formed in a battery cell module decreases in size, reducing the cooling effect. As a result, heat generation between battery cells due to temperature rising of adjacent battery cells is accelerated to cause a rapid reduction in the battery performance.

When the volume expansion of the battery cell is excessive, the pouched-type case of the battery cell can be damaged to cause electrolyte and gas leakage from the inside.

Since the battery cell module is configured by stacking a plurality of battery cells, the volume expansion of the battery cell, or the gas leakage or explosion can directly damage adjacent cells.

On the other hand, the air cooling channel between cells of a battery cell module is necessarily formed for effective heat radiation. However, since a space of about 3 mm or more is needed between all battery cells, there is a limitation in increasing energy density versus volume.

Most studies that have been completed for mass-production or are being currently conducted are approaching development of battery case and housing materials only from a viewpoint of heat radiation. When the working temperature of batteries is excessively high (e.g., above 50° C.) or low (e.g., below 0° C.), the lifespan of batteries can be fatally affected. Accordingly, appropriate temperature control is necessary for the performance and the lifespan of batteries.

For example, typical battery case and housing materials, in which 20 to 30 wt % mineral filler, i.e., an incombustible filler is filled in a plastic matrix such as PC+ABS, PA, and PP, have functions such as frame resistance, chemical resistance, insulation characteristics, and durability, but lack ideal heat radiation characteristics.

Accordingly, a separate heat control system for a battery cell module for maintaining an optimum temperature is needed to maintain the battery performance and secure the stability under various operation and temperature conditions.

The above information disclosed in this Background section is only for enhancement of understanding of the background of the invention and therefore it can contain information that does not form the prior art that is already known in this country to a person of ordinary skill in the art.

### SUMMARY OF THE DISCLOSURE

The present invention provides a heat control plate and a battery cell module having the same, which is an interface component interposed between battery cells, and can maintain an optimum temperature of a battery under various operation and temperature conditions and accommodate a volume variation of a battery cell.

In one aspect, the present invention a heat control plate for a battery cell module as an interfacial component interposed between battery cells, including: a planar composite sheet; a plurality of heat radiating ribbons penetrating the composite sheet and protruding from both right and left sides of the composite sheet at both ends thereof; a planar heating layer attached to one or both of upper and lower surfaces of the composite sheet and generating heat upon application of a voltage; and a conductive strap applying a supply voltage to the planar heating layer.

In an exemplary embodiment, the planar composite sheet can have a high thermal conductivity. The planar composite sheet can have a thermal conductivity greater than about 3 W/mK.

In another exemplary embodiment, the composite sheet can be formed of an elastomer resin including a filler with high thermal conductivity. The filler can include one or more selected from the group consisting of: graphite, carbon nanotubes, carbon black, boron nitride, aluminum nitride, steel fiber, and silver powder.

In another exemplary embodiment, the composite sheet can include a thermoplastic elastomer resin of about 50 wt % to about 80 wt % and a filler of about 20 wt % to about 50 wt %.

In still another exemplary embodiment, the thermoplastic elastomer resin can include one of thermoplastic polyurethane (TPU) and styrene-ethylene-butylene-styrene (SEBS).

In yet another exemplary embodiment, the filler can include one selected from the group consisting of graphite, carbon nanotube, carbon black, boron nitride, aluminum nitride, steel fiber, silver powder, and a combination thereof.

In still yet another exemplary embodiment, the heat radiating ribbons can protrude from both right and left sides of the composite sheet by about 5 mm to about 20 mm.

In a further exemplary embodiment, the heat radiating ribbon can be formed of a metallic material with high thermal conductivity. The metallic material can have a thermal conductivity greater than about 60 W/mK. The metallic material can have a thermal conductivity between about 60 W/mK and about 300 W/mk.

In another further exemplary embodiment, the planar heating layer can have a thickness of about 10 μm to about 30 μm.

In still another further exemplary embodiment, the planar heating layer can be connected to a temperature sensor for sensing a surface temperature of the battery cell, and the temperature sensor can be connected to a temperature control unit that turns on/off a power supply unit for supplying power to the conductive strap 14 according to a signal of the temperature sensor.

In yet another further exemplary embodiment, the conductive strap can be attached between the planar heating layer and the composite sheet, and can be disposed at both right and left ends of the composite sheet to be electrically connected to a power supply unit.

In another aspect, the present invention provides a battery cell module including a plurality of battery cells stacked in a multilayer and a plurality of heat control plates interposed between the battery cells, the heat control plate including: a planar composite sheet; a plurality of heat radiating ribbons penetrating the composite sheet and protruding from both right and left sides of the composite sheet at both ends thereof; a planar heating layer attached to one or both of upper and lower surfaces of the composite sheet and generating heat upon application of a voltage; and a conductive strap applying a supply voltage to the planar heating layer.

In an exemplary aspect, the planar composite sheet has a high thermal conductivity. The planar composite sheet can have a thermal conductivity greater than about 3 W/mK.

In another exemplary embodiment, the heat control plate can include an electrode part of the conductive strap outwardly protruding from the composite sheet, and the electrode part can be electrically connected by an electrode connection member at both sides of the battery cell.

Other aspects and exemplary embodiments of the invention are discussed infra.

### DEFINITIONS

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a plan and front view illustrating a heat control plate for a battery cell module according to an embodiment of the present invention;

FIG. 2 is a cross-sectional view taken along lines A-A and B-B of FIG. 1;

FIG. 3 is a view illustrating a power supply unit connected to a heat control plate for a battery cell module according to an embodiment of the present invention;

FIG. 4 is a front view illustrating a battery cell module including a heat control plate according to an embodiment of the present invention;

FIG. 5 is a partially magnified front view of FIG. 4; and

FIG. 6 is a partially magnified side view of FIG. 4.

Reference numerals set forth in the Drawings includes reference to the following elements as further discussed below:
10: heat control plate
11: composite sheet
12: heat radiating ribbon
13: planar heating layer
14: conductive strap
15: electrode part of conductive strap
16: electrode connection member
17: temperate sensor
18: temperature control unit
19: power supply unit
20: battery cell
21: electrode part of battery cell

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which can be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The above and other features of the invention are discussed herein.

A heat control system for a battery cell module with both heating and heat radiation characteristics for maintaining an optimum temperature can be needed to improve the performance and secure the stability of a battery system for an electric vehicle.

Thus, the present invention provides a heat control plate for a battery cell module, which can maintain battery cells and modules at an optimum temperature to prevent the reduction of the battery performance.

A heat control plate for a battery cell module according to an embodiment of the present invention, which is an interfacial component disposed between stacked battery cells to control heat radiation and heating of the battery cell module, can include materials and structures that can maintain an optimum temperature of the battery cell module by performing heat radiation under a typical climate condition and performing heating under a low temperature environment to prevent the performance reduction of the battery cell module and secure the lifespan and the stability of the battery cell module.

Hereinafter, exemplary embodiments of the present invention will be described in detail with reference to the accompanying drawings.

A heat control plate for a battery cell module according to an embodiment of the present invention can be configured with a structure that can maximize the heat radiation characteristics using materials with high thermal conductivity. Heat radiation fillers filled in the heat control plate can form an effective heat transfer path to have the heat radiation characteristics.

The heat control plate, which is an interfacial component interposed between battery cells, can accommodate the volume variation (expansion/contraction of cells) of the cells as well as have heat radiation performance abilities. Accordingly, the heat control plate can be configured to have high elasticity (compression and resilience) to accommodate the volume variation of the battery cells caused by charging and discharging.

Since the heat control plate is an interfacial component that directly contacts the battery cells, the heat control plate can be formed of materials (materials like elastomer described later) that can achieve the surface smoothness with cells and increase the adhesion and grip properties. The heat control plate can be configured to minimize a heat conduction interfacial resistance generated at an interface between the battery cell and the heat control plate.

Thus, the heat control plate 10 according to the embodiment of the present invention can be configured to include a planar composite sheet 11 formed with a composite in which a filler with high thermal conductivity is added to a polymer resin with high elasticity.

The polymer resin can include a thermoplastic elastomer resin to accommodate the volume variation of the battery cell caused by charging and discharging.

The thermoplastic elastomer resin can include one of thermoplastic polyurethane (TPU) and styrene-ethylene-butylene-styrene (SEBS).

In order to achieve a compact battery system for improving energy density versus volume, the elasticity and heat radiation performance of a material capable of dealing with the volume variation of the battery cell need to be sufficient.

For this, a plurality (e.g., about fifteen to about forty) heat radiating ribbons 12 with high thermal conductivity can be inserted into the composite sheet 11 to improve the heat radiation performance.

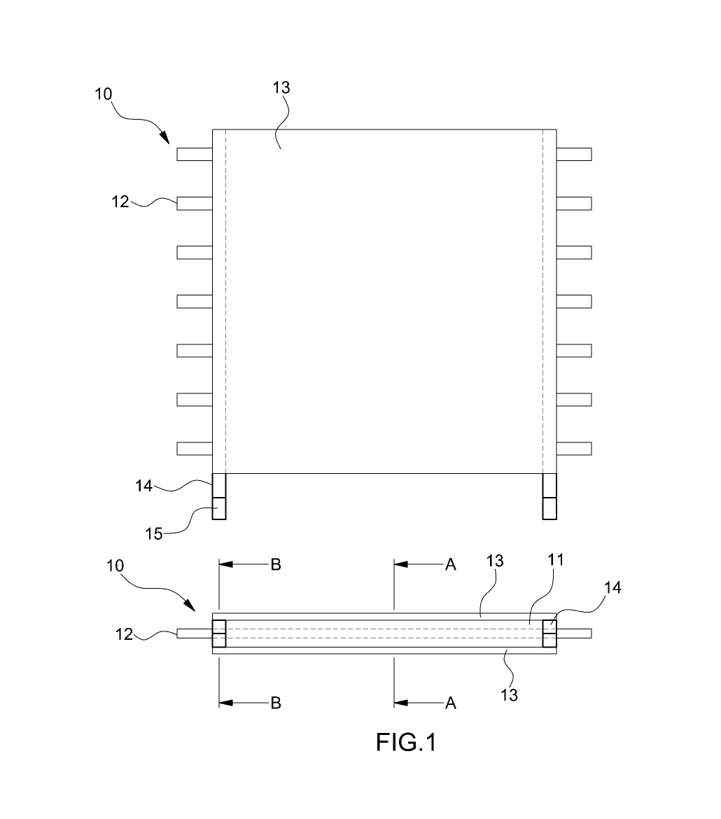

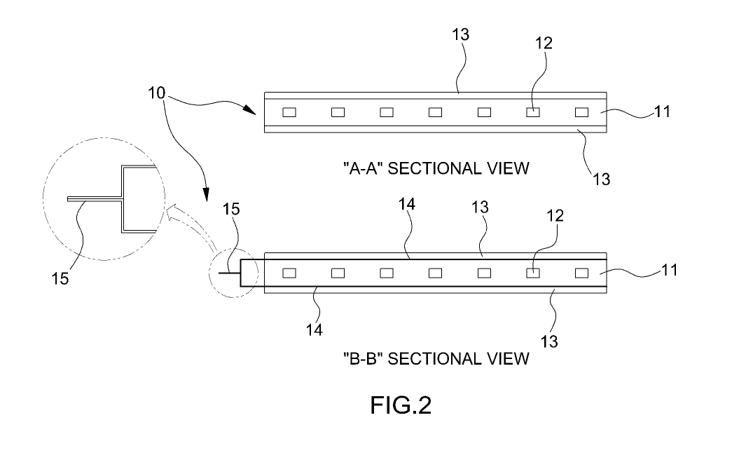

The heat radiating ribbon 12 can be integrally formed with the composite sheet 11 as an insertion into the composite sheet 11 by overmolding injection. As described above FIGS. 1 and 2, the heat radiating ribbon 12 can protrude from the right and left sides of the composite sheet 11 at both end thereof.

The heat radiating ribbons 12 can be inserted into the composite sheet 11 in the plane direction (or longitudinal direction) and can be parallelly spaced from each other.

In this case, the composite sheet 11 can be configured to have the same width and length as the pouched-type battery cell. The heat radiating ribbon 12 can have a width of about 2 mm to about 8 mm, and can protrude from the composite sheet 11 by about 5 mm to about 20 mm at the both right and left sides thereof to serve as a heat radiating fin.

When the heat control plate 10 is interposed between battery cells, the heat control plate 10 can have a structure similar to a heat sink formed using heat radiating fins with a maximized specific surface area.

Thus, since the heat control plate 10 includes the heat radiating ribbon 12 having a similar structure to a heat sink as a heat radiating fin to achieve a heat radiation effect using air cooling at both right and left sides (as opposed to a single side of the composite sheet 11), the heat control plate 10 can minimize a heat transfer path and a local temperature difference inside a battery by transferring heat generated over the battery cell in both directions (both sides from which heat radiating ribbon protrude).

The heat radiating ribbon 12 can be formed of a metallic material, for example, an aluminum material with a high thermal conductivity.

The heat conduction characteristics of the composite sheet 11 can range from about 3 W/mK to about 5 W/mK to effectively transfer heat generated in the battery cell to the heat radiating ribbon 12.

Thus, the filler with high thermal conductivity described above can be filled in the polymer resin to form an effective heat transfer path in the composite sheet 11.

The filler in the polymer resin can include one selected from the group consisting of graphite, carbon nanotube, carbon black, boron nitride, aluminum nitride, steel fiber, silver powder, and a combination thereof.

Here, the composite sheet 11, which is a mixture of the polymer resin and the filler with high thermal conductivity, can include about 50 wt % to about 80 wt % polymer resin and about 20 wt % to about 50 wt % filler.

When the weight of the filler of the composite sheet 11 is less than about 20 wt %, desired heat conduction characteristics can not be achieved. On the other hand, when the weight of the filler of the composite sheet 11 is greater than about 50 wt %, the physical properties of the material can be reduced, or the grip property (elasticity) can be reduced.

The composite sheet 11 can include an elastomer material with sufficient grip property as a matrix material. Thus, sufficient heat conduction characteristics can be achieved by minimizing pores at an interface with a battery cell that is a heat source. Also, the stability and durability can be improved against shocks and vibrations.

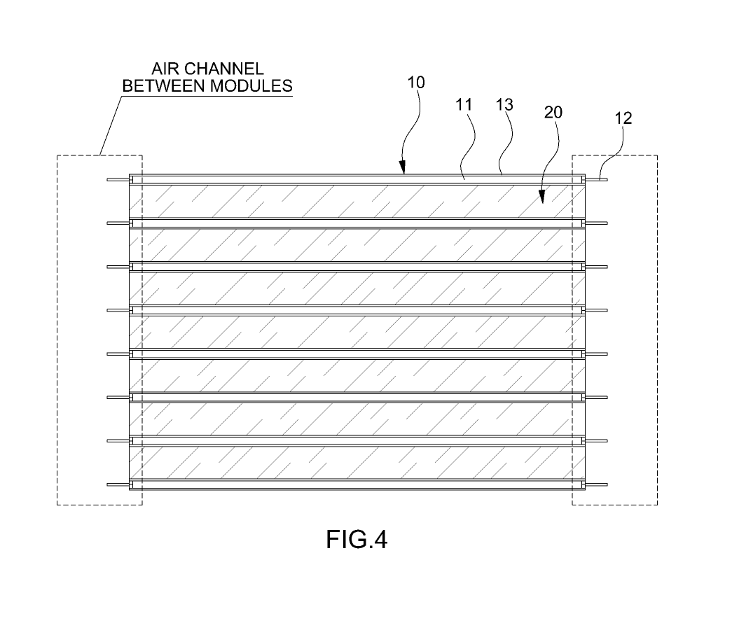

When mounted in a battery case, a battery cell module (see FIG. 4) including the heat control plate 10 configured as above can have a cooling air channel orthogonal to the plane direction of the heat control plate 10 between modules. Cooling air can flow in a direction orthogonal to the heat radiating ribbon 12 in the channel, increasing the heat radiation effect by convection.

When the heat control plate 10 is disposed between stacked battery cells (20 of FIG. 4), the cooling air channel formed at edges of the module can be orthogonal to the plane direction of the heat control plate 10 (or the flow direction of cooling air is orthogonal to the stack direction of the battery cells and the heat control plates), increasing the energy density of the battery cell module in the equal volume compared to a typical air cooling heat radiating system.

On the other hand, a separate heating system can be optionally included to allow the battery to normally operate under a low temperature environment.

Thus, the heat control plate 10 can be configured to perform both heat radiation and heating by stacking a planar heating layer 13 on the surface of the composite sheet 11 with high elasticity and heat radiation performance.

The planar heating layer 13 can be a polymer resistor that can generate heat by an applied voltage, and can be configured by coating a coating solution on the surface of the composite sheet 11. The coating solution can heat up to a desired temperature in a short time at a low voltage of about 12 V to about 24 V.

The coating solution can be formed using commercially available materials.

When a voltage is applied, the planar heating layer 13 can generate heat to increase the temperature of the battery cell 20 bonded to the composite sheet 11. As shown in FIGS. 1 and 2, the planar heating layer 13 can be coated on the upper and lower surfaces of the composite sheet 11 such that heat can be effectively transferred to the battery cells bonded to both surfaces of the composite sheet 11. Accordingly, the reduction of the battery performance can be effectively prevented at a low temperature.

In a battery system, it is important to maintain a uniform temperature without a temperature deviation over the whole surface of the battery cell.

Thus, the planar heating layer 13 can induce a uniform temperature rising over the whole area of the battery cell 20 bonded to the heat control plate 10. To this end, the planar heating layer 13 can be coated on the surface of the composite sheet 11 in a thickness of about 10 μm to about 30 μm.

Since the planar heating layer 13 is a thin plate with a thickness of about 10 μm to about 30 μm, the planar heating layer 13 can uniformly generate heat without occurrence of a hot spot when a voltage is applied.

Since the planar heating layer 13 is thin and flexible, the planar heating layer 13 does not significantly affect the grip property and the elasticity of the composite sheet 11. Accordingly, the heat radiation characteristics and the stability of the heat control plate 10 due to the composite sheet 11 can be maintained.

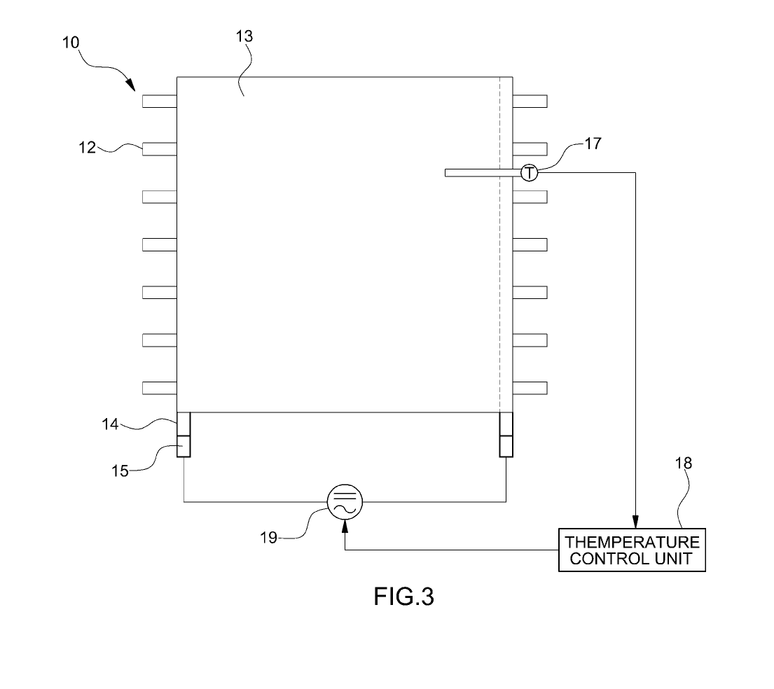

A conductive strap 14 can be connected to the planar heating layer 13 to deliver power supplied from the power supply unit (19 of FIG. 3).

As shown in FIG. 2, the conductive strap 14 can be a thin and long strip that is interposed between the planar heating layer and the composite sheet 11. The conductive strap 14 can be disposed at the right and left ends on the upper and lower surfaces of the composite sheet 11. One end of the conductive strap 14 attached to the upper and lower surfaces of the composite sheet 11 can be bonded to each other outside the composite sheet 11 to form an electrode part 15.

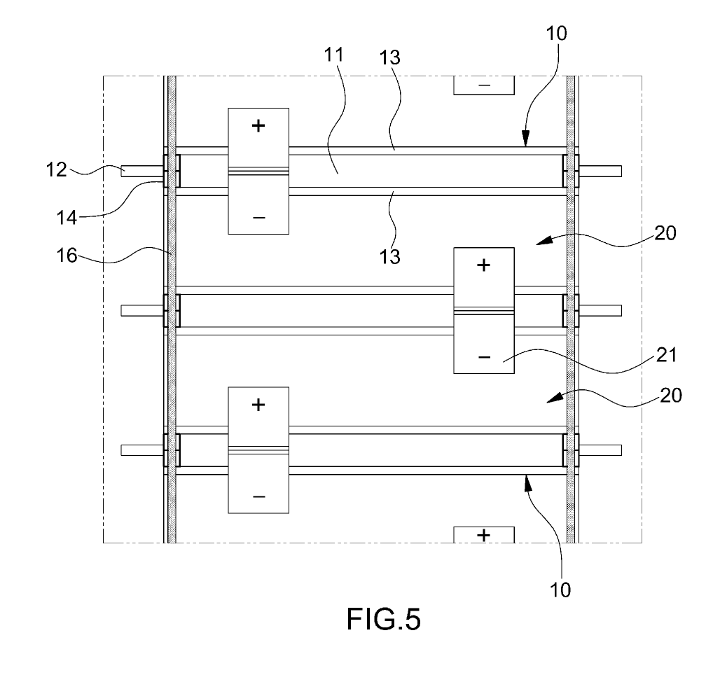

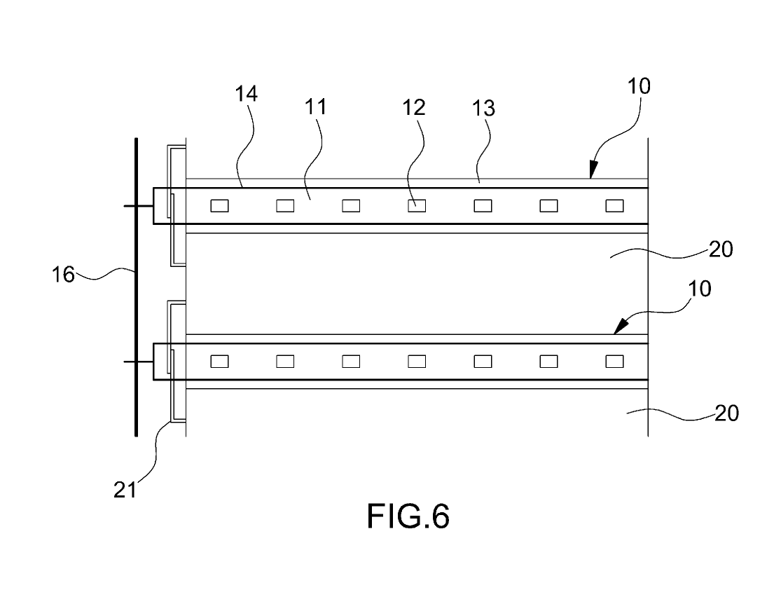

As shown in FIGS. 5 and 6, the electrode part 15 of the conductive straps 14 at both right and left sides can forwardly protrude from the heat control plate 10 outside the battery cell 20 to serve as an electrode connected to the positive electrode and the negative electrode of the power supply unit 19. The electrode parts 15 of the conductive straps 14 can be integrally (or electrically) connected to each other by an electrode connection member 16 to serve as electrodes connected to the positive electrode and the negative electrode of the power supply unit 19.

Thus, a voltage of the power supply unit 19 can be applied to the planar heating layer 13 through the conductive strap 14.

The conductive strap 14 can be attached to the composite sheet 11 before the planar heating layer 13 is coated. After the conductive strap 14 is attached, the planar heating layer 13 can be formed by a coating process using a bar coater.

As shown in FIG. 3, an optional temperature sensor 17 can be connected to the surface of the planar heating layer 13 of the heat control plate 10 to maintain an optimum temperature of the battery cell. The temperature sensor 17 can be connected to a temperature control unit 18 that turns on/off the power supply unit 19 for supplying power to the conductive strap 14 according to signals of the temperature sensor 17.

The temperature sensor 17 can sense the surface temperature of the battery cell contacting the planar heating layer 13. The temperature control unit 18 receiving signals from the temperature sensor 17 can turn on/off the power supply unit 19 according to the signals of the temperature sensor 17 to control heating of the planar heating layer 13.

In the heat control plate 10, the thickness and the width of the heat radiating ribbon 12 and the interval between the heat radiating ribbons 12 can be changed based on the heat radiation characteristics required according to a heating value of the battery system. The final thickness of the heat control plate 10 including the composite sheet 11, the heat radiating ribbon 12, and the planar heating layer 13 can be smaller than a channel space between modules of a typical battery system.

The heat control plate 10 can maintain the battery cell module at an optimum temperature by radiating heat upon temperature rising of the battery cell and generating heat if a temperature falls below an optimum working temperature range of the battery cell for preventing the reduction of the battery performance.

Referring to FIG. 4, the battery cell module according to the embodiment of the present invention can include a plurality of battery cells 20 that are stacked to form a multilayer assembly with a plurality of heat control plates 10 interposed between the battery cells 20.

The battery cell module can be maintained within an optimum temperature range for the normal operation by the heat control plate 10 interposed between the battery cells 20, and can accommodate the volume expansion of the battery cell 20 due to charging and discharging.

The heat control plate 10 can be manufactured by the following processes.

First, about 15 to about 40 heat radiating ribbons 12 with a width of about 2 mm to about 8 mm, a length of about 280 mm to about 290 mm, and a thickness of about 1 mm or less can be prepared.

The heat radiating ribbons 12 can be inserted into a mold at a uniform interval, and then a composite sheet 11 including the heat radiation ribbons 12 therein can be manufactured by overmolding injection.

The heat radiating ribbon 12 can be longer than the battery cell 20, protruding from the battery cell 20 by about 5 mm to about 20 mm at both sides of the battery cell 20.

The polymer resin of the composite sheet 11 can include styrene-ethylene-butadiene-styrene (SEBS) that is a thermoplastic elastomer resin. The heat conduction characteristics of the composite sheet 11 can be allowed to range from about 3 W/mK to about 5 W/mK by adding about 20 wt % to about 50 wt % with high thermal conductivity to a selected polymer resin.

In order to give a heating function to the upper and lower surfaces of the composite sheet 11, a strap type of conductor (conductive strap) 14 connected to the power supply unit 19 can be attached to both right and left ends (for a total of four locations) of the upper and lower surfaces of the composite sheet 11, and then a conductive coating solution for a planar heating body can be coated over the upper and lower surfaces of the composite sheet 11 and the conductive strap 14 in a uniform thickness of about 10 μm to about 30 μm using a bar coater.

The coating solution can include a commercially available Carbo e-therm ACR-100 1W coating of Future Carbon Inc.

The four conductive straps 14 attached to both right and left ends of the upper and lower surfaces of the composite sheet 11 can be vertically bonded to each other to form electrode parts 15 at each side of the composite sheet 11, respectively.

The electrode part 15 of the conductive strap 14 that are mutually bonded can forwardly protrude from both right and left sides of the composite sheet 11 to serve as a positive electrode and a negative electrode that can be connected to the electrode of the power supply unit 19.

The heat control plate 10 can be respectively interposed between the stacked plurality of battery cells 20 to form one battery cell module. The electrode parts 21 of each battery cell 20 can be folded to be bonded to each other (see FIG. 5).

The heat radiating ribbons 12 of the heat control plate 10 interposed between the battery cells 20 in the battery cell module protrude from both right and left sides of the battery cells.

The electrode parts 15 of the conductive straps 14 that are vertically stacked can be electrically connected to each other by the bus bar 16.

The temperature sensor 17 can be attached and connected to the coated surface (planar heating layer 13) of the heat control plate 10, and can be connected to the temperature control unit 18 connected to the power supply unit 19.

The temperature sensor 17 can sense the surface temperature of the battery cell 20 to transmit a signal to the temperature control unit 18, and can control whether to turn on or off the power supply unit 19 according to the signal received from the temperature control unit 18 to maintain the surface temperature of the battery cell 200 within an optimum temperature range of about 35° C. to about 40° C.

The power supply unit 19 can be configured to supply optimum power according to the number of the heat control plates 10 interposed between the battery cells 20 in consideration of the total output of a battery pack including a plurality of modules.

Also, the power of the battery can be used by connecting to the electrode part 21 of the battery cell 20 instead of using a separate power supply unit to supply power for heating the planar heating layer 13.

A heat control plate for a battery cell module according to an embodiment of the present invention can be interposed between battery cells, and can appropriately maintain the internal temperature of a battery cell module by radiating heat upon temperature rising of a battery cell and supplying thermal energy from a planar heating layer upon temperature falling and accommodate a temperature variation during charging and discharging of the battery cell, based on an optimum working temperature range of the battery cell.

Thus, a battery cell module having the heat control plate can be improved in heat control performance, and can achieve a compact heat radiation and heating system with improved energy density versus volume. Also, the battery cell module can improve the battery performance and can simultaneously secure the lifespan, the stability, and reliability of a battery.

The invention has been described in detail with reference to exemplary embodiments thereof. However, it will be appreciated by those skilled in the art that changes can be made in these embodiments without departing from the principles and spirit of the invention, the scope of which is defined in the appended claims and their equivalents.

What is claimed is:

1. A heat control plate for a battery cell module as an interfacial component interposed between battery cells, comprising:
a planar composite sheet;
a plurality of heat radiating ribbons penetrating the composite sheet and protruding from both right and left sides of the composite sheet at both ends thereof;
a planar heating layer attached to one or both of upper and lower surfaces of the composite sheet and generating heat upon application of a voltage; and
a conductive strap applying a supply voltage to the planar heating layer.

2. The heat control plate of claim 1, wherein the planar composite sheet has a high thermal conductivity.

3. The heat control plate of claim 2, wherein the planar composite sheet has a thermal conductivity greater than about 3 W/mK.

4. The heat control plate of claim 1, wherein the composite sheet is formed of an elastomer resin comprising a filler having high thermal conductivity.

5. The heat control plate of claim 4, wherein the filler comprises one or more selected from the group consisting of: graphite, carbon nanotubes, carbon black, boron nitride, aluminum nitride, steel fiber, and silver powder.

6. The heat control plate of claim 1, wherein the composite sheet comprises a thermoplastic elastomer resin of about 50 wt % to about 80 wt % and a filler of about 20 wt % to about 50 wt %.

7. The heat control plate of claim 6, wherein the thermoplastic elastomer resin comprises one of thermoplastic polyurethane (TPU) and styrene-ethylene-butylene-styrene (SEBS).

8. The heat control plate of claim 1, wherein the heat radiating ribbons protrude from both right and left sides of the composite sheet by about 5 mm to about 20 mm.

9. The heat control plate of claim 1, wherein the heat radiating ribbon is formed of a metallic material with high thermal conductivity.

10. The heat control plate of claim 1, wherein the metallic material has a thermal conductivity greater than about 60 W/mK.

11. The heat control plate of claim 1, wherein the metallic material has a thermal conductivity between about 60 W/mK and about 300 W/mK.

12. The heat control plate of claim 1, wherein the planar heating layer has a thickness of about 10 μm to about 30 μm.

13. The heat control plate of claim 1, wherein the planar heating layer is connected to a temperature sensor for sensing a surface temperature of the battery cell, and the temperature sensor is connected to a temperature control unit that turns on/off a power supply unit for supplying power to the conductive strap according to a signal of the temperature sensor.

14. The heat control plate of claim 1, wherein the conductive strap is attached between the planar heating layer and the composite sheet, and is disposed at both right and left ends of the composite sheet to be electrically connected to a power supply unit.

15. A battery cell module comprising a plurality of battery cells stacked in a multilayer and a plurality of heat control plates interposed between the battery cells, the heat control plate comprising:
a planar composite sheet;
a plurality of heat radiating ribbons penetrating the composite sheet and protruding from both right and left sides of the composite sheet at both ends thereof;
a planar heating layer attached to one or both of upper and lower surfaces of the composite sheet and generating heat upon application of a voltage; and
a conductive strap applying a supply voltage to the planar heating layer.

16. The battery cell module of claim 15, wherein the planar composite sheet has a high thermal conductivity.

17. The battery cell module of claim 15, wherein the planar composite sheet has a thermal conductivity greater than about 3 W/mK.

18. The battery cell module of claim 15, wherein the heat control plate comprises an electrode part of the conductive strap outwardly protruding from the composite sheet, and the electrode part is electrically connected by an electrode connection member at both sides of the battery cell.
